(19) United States
(12) Patent Application Publication
(10) Pub. No.: US 2025/0377854 A1
(43) Pub. Date: Dec. 11, 2025

(54) METHOD FOR MANAGING AUDIO BETWEEN DIFFERENT DEVICES AND AUDIO PLAYBACK SYSTEM

(71) Applicant: MediaTek Singapore Pte. Ltd., Singapore (SG)

(72) Inventor: Lei HUANG, Wuhan (CN)

(21) Appl. No.: 18/771,105

(22) Filed: Jul. 12, 2024

(30) Foreign Application Priority Data
Jun. 6, 2024 (CN) 202410732600.0

(51) Int. Cl. G06F 3/16

(52) U.S. Cl. CPC G06F 3/165

(57) ABSTRACT

A method for managing audios between different devices is provided. The method includes playing a first audio via a first electronic device. The method further includes receiving, via a central device, a request to play a second audio from a second electronic device. The method further includes the central device determining whether the second audio is allowed to be played, according to the priority of the first audio and the priority of the second audio. The method further includes playing or not playing the second audio on the second electronic device, after receiving a response from the central device.

### CROSS REFERENCE TO RELATED APPLICATIONS

This application claims the benefit of China Application No. 202410732600.0, filed on Jun. 6, 2024, the entirety of which is incorporated by reference herein.

### BACKGROUND OF THE INVENTION

### Field of the Invention

The present invention relates to a method for managing audios between different devices, and, in particular, to a method for managing audios between different devices using a central device.

### Description of the Related Art

When there are many devices playing audio at the same time, the audio from different devices will mixed up with each other. However, the current audio management method can only be applied to one device or one operating system. Thus, a method for managing audios from different devices or different operating systems is required.

### BRIEF SUMMARY OF THE INVENTION

An embodiment of the present invention provides a method for managing audios between different devices. The method includes playing a first audio via a first electronic device. The method further includes the following steps. A central device receives a request to play a second audio from a second electronic device. The central device determines whether the second audio is allowed to be played, according to the priority of the first audio and the priority of the second audio. After receiving a response from the central device, the second electronic device may or may not play the second audio.

An embodiment of the present invention provides an audio playback system. The audio playback system includes a central device, a first electronic device, and a second electronic device. The central device is configured to receive a request to play a second audio from a second electronic device. The central device is further configured to determine whether the second audio is allowed to be played, according to the priority of the first audio and the priority of the second audio. The second electronic device is configured to play or not to play the second audio, after receiving a response from the central device.

### BRIEF DESCRIPTION OF THE DRAWINGS

The present invention can be more fully understood by reading the subsequent detailed description and examples with references made to the accompanying drawings, wherein:

FIGS. 1A and 1B are blocks diagram of an audio playback system in accordance to the embodiments of the present disclosure;

FIGS. 2-1˜2-3 are schematic diagrams of a method for managing audios between different devices in accordance to the embodiments of the present disclosure;

FIGS. 3-1˜3-2 are schematic diagrams of a method for managing audios between different devices in accordance to the embodiments of the present disclosure;

FIG. 4 is a schematic diagram of a method for managing audios between different devices in accordance to the embodiments of the present disclosure;

FIGS. 5-1˜5-4 are schematic diagrams of a method for managing audios between different devices in accordance to the embodiments of the present disclosure; and

FIG. 6 is a flow diagram of a method for managing audios between different devices in accordance to the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

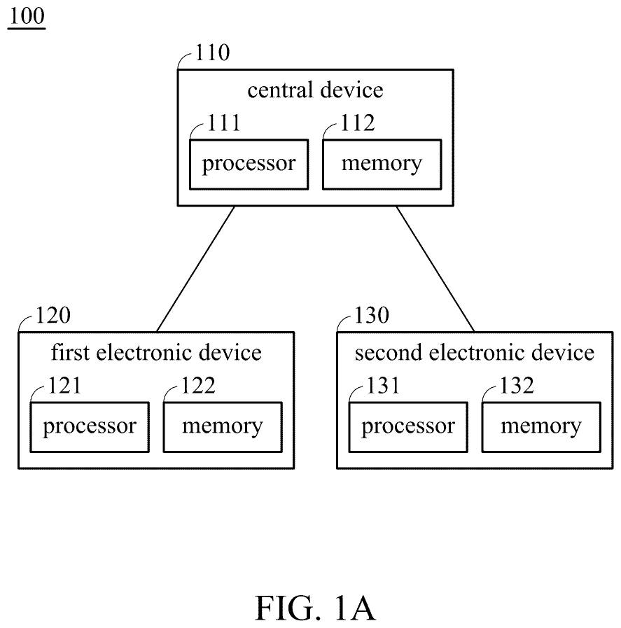

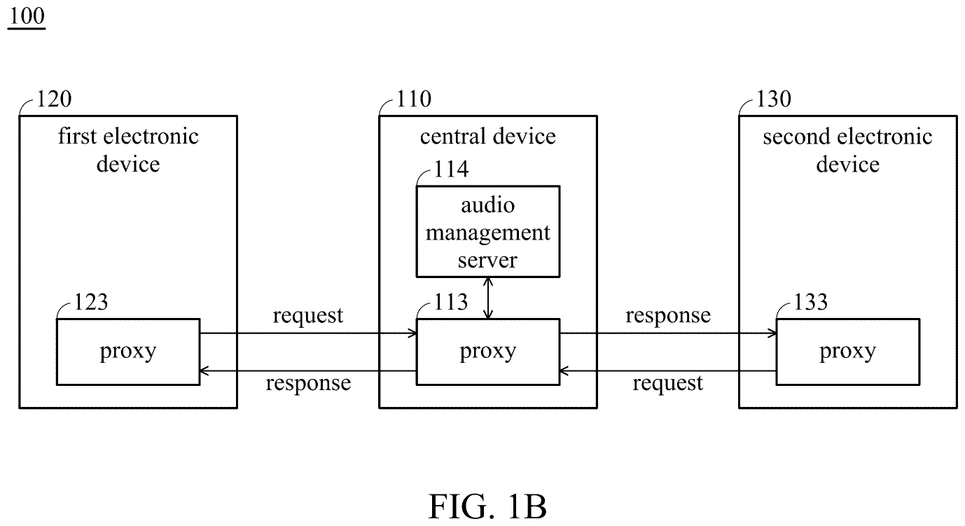

Refer to FIG. 1A, which is a block diagram of an audio playback system 100 in accordance to the embodiments of the present disclosure. The audio playback system 100 includes a central device 110, a first electronic device 120, and a second electronic device 130. The central device 110, the first electronic device 120, and the second electronic device 130 may perform various functions to implement processes and methods described herein. In some embodiments, the central device 110, the first electronic device 120, and the second electronic device 130 may be mobile apparatus, computing apparatus, or wearable device. For example, the central device 110, the first electronic device 120, and the second electronic device 130 may be cell phone, tablet computer, notebook computer, smartwatch, navigation device, a television, car television, car display, or video display device. In some embodiments, the central device 110, the first electronic device 120, and the second electronic device 130 are mounted on a vehicle (such as a car). In other words, the audio playback system 100 is in a vehicle.

The central device 110 includes a processor 111 and a memory 112. The first electronic device 120 includes a processor 121 and a memory 122. The second electronic device 130 includes a processor 131 and a memory 132. The central device 110, the first electronic device 120, and the second electronic device 130 may be implemented in the form of one or more integrated-circuit (IC) chips such as one or more processors.

The processor 111 controls operations of the central device 110. The processor 111 provides the required process ability to perform operating systems, programs, software, modules, applications, and functions of the central device 110. In some embodiments, processor 111 may be implemented in the form of hardware with electronic components, such as transistors, diodes, capacitors, resistors, or inductors. These components are configured and arranged to achieve specific purposes in accordance with the present disclosure. The processor 111 may include one or more processing units. For example, the processor 111 may include a general purpose micro-processor, a central processing unit (CPU), an application processor, a graphics processing unit (GPU), an image signal processor, a controller, a digital signal processor, and/or related chip set. Different processing units may be independent components, or may be integrated into other processing units.

The memory 112 stores data required by the processor 111. The memory 112 may include non-volatile memories, such as read only memory (ROM) and flash memory. The memory 112 may also include volatile memories, such as dynamic random access memory (DRAM) and static random access memory (SRAM). In some embodiments, the memory 112 stores at least one program (e.g. computer-readable instruction). The program can be read by the processor 111. When the program is operated by the processor 111, the program causes the processor 111 to implement methods according to the embodiments of the present disclosure.

The processor 121 and the processor 131 are similar to the processor 111, and the memory 122 and the memory 132 are similar to the memory 112. Moreover, the central device 110, the first electronic device 120, and the second electronic device 130 may include other components, which are not shown in FIG. 1A. In some embodiments, the central device 110, the first electronic device 120, and the second electronic device 130 further include a display, a touch screen, an user interface device (e.g. mouse and keyboard), a speaker, a wireless communication circuit, an antenna, or an internal power supply. In some embodiments, the central device 110, the first electronic device 120, and the second electronic device 130 have different operating systems. For example, the operating system of the central device 110 is Linux, the operating system of the first electronic device 120 is Android, and the operating system of the second electronic device 130 is Android or IOS.

Refer to FIG. 1B, which is a block diagram of an audio playback system 100 in accordance to the embodiments of the present disclosure. As shown in FIG. 1B, the central device 110 further includes a proxy 113 and an audio management server 114. The first electronic device 120 further includes a proxy 123. The second electronic device 130 further includes a proxy 133. The central device 110, the first electronic device 120, and the second electronic device 130 communicates with each other through the proxy 113, 123, and 133, respectively. Proxy 113, 123 and 133 are a set of standardized interfaces. For example, standardized interfaces are used to provide a unified and standard way for interaction and data exchange between different operating systems, thereby simplifying communication between different operating systems and ensuring that data and commands can be processed and processed in a consistent manner.

When the first electronic device 120 and the second electronic device 130 have an audio to play, the first electronic device 120 and the second electronic device 130 transmits a request to play the audio to the central device 110 through the proxy 123 and 133. The central device 110 receives the requests through the proxy 113. Then, the central device 110 determines whether the audio is allowed to be played using the audio management server 114. The central device 110 transmits the response to the first electronic device 120 and the second electronic device 130 through the proxy 113 in order to control the first electronic device 120 and the second electronic device 130 to or not to play the audio. As a result, after receiving the response from the central device 110, the first electronic device 120 and the second electronic device 130 either do or do not play the audio following the indication of the response. Moreover, when the central device 110 has an audio to play, the central device 110 (e.g. an application in the central device 110) transmits a request to play the audio to the audio management server 114 through the proxy 113 and receives a response from the audio management server 114. The audio management server 114 determines whether the audio is allowed to be played according to the priorities of the audios. In some embodiments, these priorities of each kind of audios are stored in the memory 112 (e.g. in the form of a two-dimensional or three-dimensional table), the audio management server 114 determines the priority of each audio by looking up the two-dimensional or three-dimensional table. Suppose that there are different types of audio and different scenes, the priority of the audio can be stored using a two-dimensional table with multiple two-dimensional arrays, where the rows represent the audio types and the columns represent the scenes. A two-dimensional array can represent the priority of different audio types in different scenarios. Suppose there are different types of audio, different scenarios, and different user types. The priority of audio can be stored using a three-dimensional table with multiple three-dimensional arrays, where the first dimension represents the audio type, the second dimension represents the scene, the third dimension represents the user type, and a three-dimensional array can represent the priorities of different audio types for different user types in different scenarios. Audio management server 114 may determine the priority of audio by looking up these arrays.

The central device 110, the first electronic device 120, and the second electronic device 130 maintain synchronization with each other to determine the order of the requests. Moreover, the central device 110, the first electronic device 120, and the second electronic device 130 may communicate with each other through wired or wireless communication, such as Virtual Socket (vsock), socket, Remote Procedure Call (grpc), Ethernet, Wi-Fi, Bluetooth.

In some embodiments, the proxy 113, 123, and 133 and the audio management server 114 are software modules. These software modules are operated by the processor 111, 121, and 113. The processor 111, 121, and 113 respectively reads the programs stored in the memory 112, 122, and 132 and performs the programs to implement these software modules. In some embodiment, the proxy 113, 123, and 133 and the audio management server 114 may be installed in the central device 110, the first electronic device 120, and the second electronic device 130 in the form of an application. Thus, any electronic device installed with the application can join into the audio playback system 100. In other embodiments, the proxy 113, 123, and 133 and the audio management server 114 are hardware modules. These hardware modules may be implemented with integrated circuits. For example, the proxy 113, 123, and 133 and the audio management server 114 may be a specific chip or circuit in the central device 110, the first electronic device 120, and the second electronic device 130.

Any electronic device can join or leave the audio playback system 100 at any time. The electronic devices in the audio playback system 100 monitor for the addition or removal of device. For example, each electronic device in the audio playback system 100 transmits a predefined message to other electronic devices periodically to inform other electronic devices the existence of the electronic device. When an electronic device joins the audio playback system 100, it also transmits the predefined message (e.g. in the form of a heartbeat) to other devices in the audio playback system 100 to inform other devices that a new device has joined. When the predefined message hasn't been received from one electronic device for a predefined duration, it can be determined that the electronic device has left the audio playback system 100. When a device joins the above wired or wireless network, the device obtains the current network status from the electronic device in the audio playback system 100 and initializes it. When the device is offline normally, it can send a logout message before going offline to immediately remove from the table of the electronic device of the audio playback system 100 and perform status clearing. When the device is abnormally offline, the system 100 may also detect that the device is abnormally offline through a heartbeat. The status information related to the joining and deregistration of the device will be synchronized to other electronic devices in the audio playback system 100 to maintain the consistency of the network status.

Any electronic device in the audio playback system 100 can be selected to be the central device 110 (but there is only one central device 110 in the audio playback system 100). In some embodiments, the central device 110 is an electronic device that keeps operating (keeps the power on) after the vehicle starts up. In other words, the central device 110 is an electronic device that won't turn off while the vehicle is active. For example, the central device 110 is the central control platform of the vehicle, the display of the driver's seat, or the dashboard.

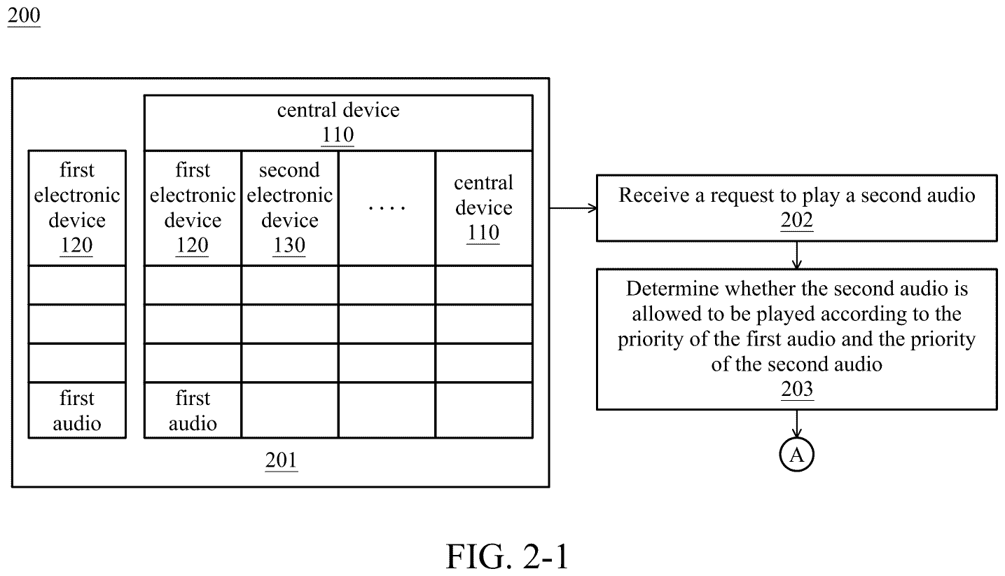

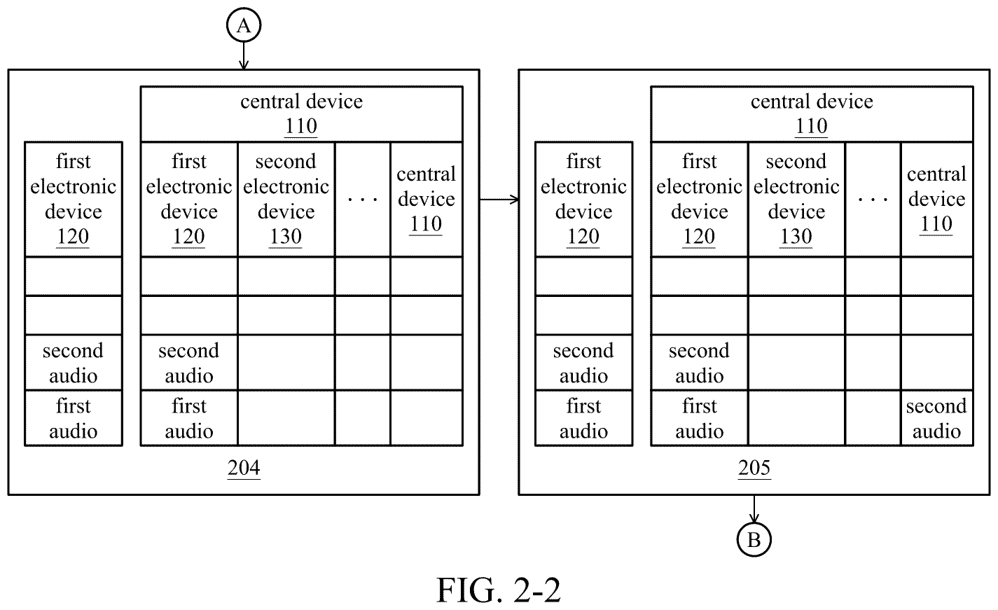

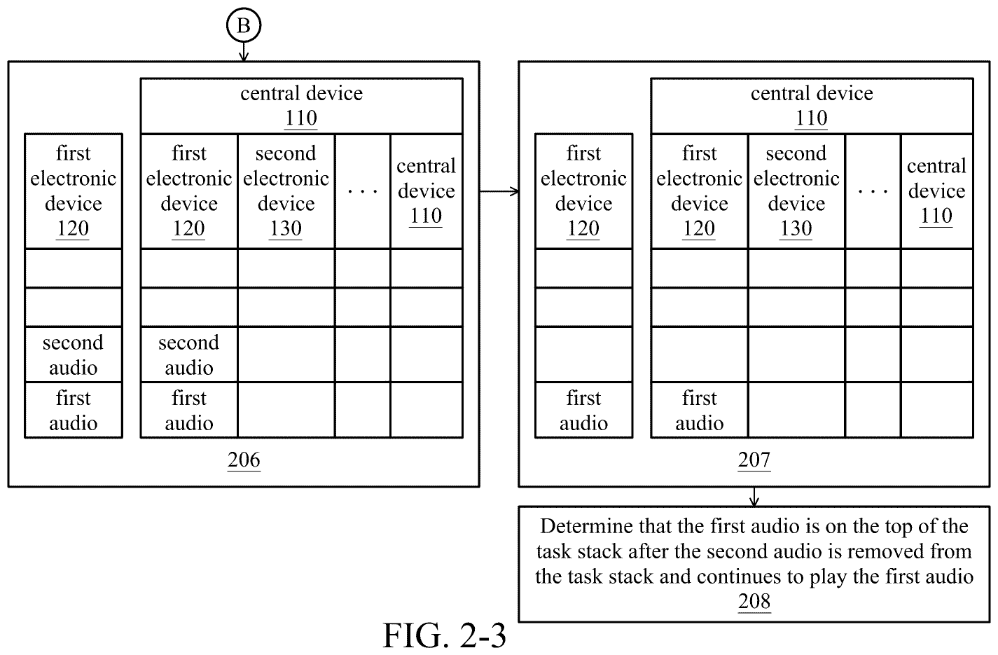

Refer to FIGS. 2-1˜2-3, which are schematic diagrams of a method 200 for managing audios between different devices in accordance to the embodiments of the present disclosure. In step 201, the first electronic device 120 plays a first audio. The block labeled with “first electronic device 120” illustrates a stack stored in memory 122 of the first electronic device 120. The stacks of the present disclosure stores tasks (such as audios required to be played) of the electronic device, and the stack is also referred to as a task stack. The electronic device in the audio playback system 100 processes the tasks in the stack following the principle of Last-In-First-Out. In other words, the latest task will be added into the top of the stack. After the task on the top of the stack is finished, the task is removed from the stack, and the electronic device processes the task in the stack under the removed task. The block labeled with “central device 110” illustrates a stack stored in memory 112 of the central device 110. The central device 110 records tasks of all the devices in the audio playback system 100, including the first electronic device 120, the second electronic device 130, and/or other devices in the audio playback system 100. Specifically, the column labeled with “first electronic device 120” in the stack of the central device 110 illustrates the stack of the first electronic device 120, and so on. Thus, in step 201, the stack of the central device 110 records the first audio in the column labeled with “first electronic device 120”.

In step 202, the audio management server 114 in the central device 110 receives a request to play a second audio from the central device 110 (or the second electronic device 130) through the proxy 113. In step 203, the audio management server 114 of the central device 110 determines whether the second audio is allowed to be played according to the priority of the first audio and the priority of the second audio. In this embodiment, the second audio has a higher priority than the first audio. Thus, the central device 110 determines that the second audio is allowed to be played, and the first audio should be stopped.

In step 204, the central device 110 controls the first electronic device 120 to add the second audio into the top of the task stack of the first electronic device 120 in order to cause the first electronic device 120 to stop playing the first audio. In some embodiments, the central device 110 controls the first electronic device 120 to add the second audio into the top of the task stack through transmitting an instruction to the first electronic device 120. Because there is another task on the first audio, the first electronic device 120 stops playing the first audio and doesn't play any audio.

In step 205, the audio management server 114 of the central device 110 informs the central device 110 (or the second electronic device 130) that the second audio is allowed to be played. Thus, the central device 110 (or the second electronic device 130) plays the second audio, after receiving the response from the central device 110. In step 206, the second audio has finished playing, and the central device 110 (or the second electronic device 130) removes the second audio from the stack of the central device 110 (or the second electronic device 130). The central device 110 (or the second electronic device 130) also informs the audio management server 114 of the central device 110 through the proxy 113 (or the proxy 133) that the second audio has finished playing. In step 207, the central device 110 notifies the first electronic device 120 that the second audio has finished playing, and the first electronic device 120 removes the second audio from the task stack of the first electronic device 120. In step 208, the first electronic device 120 determines that the first audio is on the top of the task stack after the second audio is removed from the task stack and continues to play the first audio.

By adding the task of the central device 110 (or the second electronic device 130) into the top of the stack of the first electronic device 120, the central device 110 can cause the first electronic device 120 to stop playing the first audio utilizing the control policy of the first electronic device 120. Thus, the central device 110 can easily control the first electronic device 120 to play or not to play an audio by notifying the first electronic device 120 to add a task into the stack or remove a task from the stack.

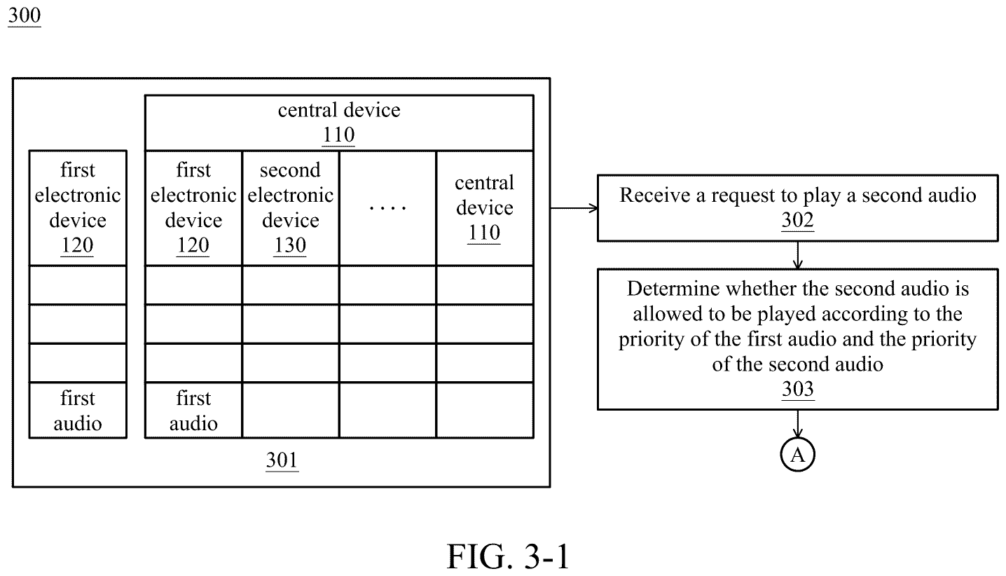

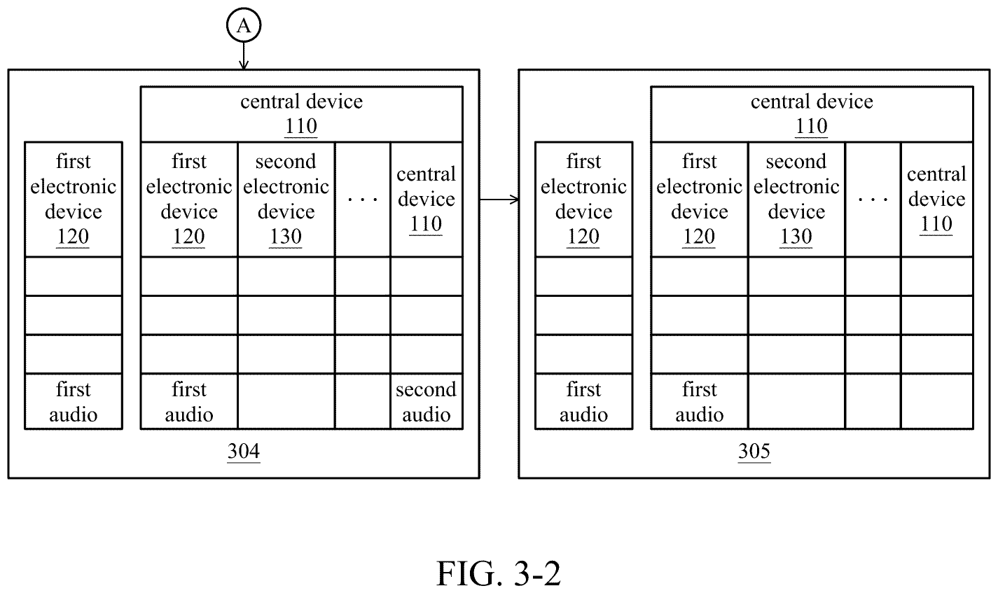

Refer to FIGS. 3-1˜3-2, which are schematic diagrams of a method 300 for managing audios between different devices in accordance to the embodiments of the present disclosure. In step 301, the first electronic device 120 plays a first audio. In step 302, the audio management server 114 in the central device 110 receives a request to play a second audio from the central device 110 (or the second electronic device 130) through the proxy 113. In step 303, the audio management server 114 of the central device 110 determines whether the second audio is allowed to be played according to the priority of the first audio and the priority of the second audio. In this embodiment, the priority of the second audio is the same as the priority of the first audio. Thus, the central device 110 determines that the second audio is allowed to be played, and there is no need to stop the first audio.

In step 304, the audio management server 114 of the central device 110 informs the central device 110 (or the second electronic device 130) that the second audio is allowed to be played. Thus, the central device 110 (or the second electronic device 130) plays the second audio after receiving the response from the central device 110, while the first electronic device 120 is playing the first audio (e.g., navigation instructions and music playback are performed at the same time). In some embodiments, the first electronic device 120 lower the volume of the first audio under the control of the audio management server 114 of the central device 110. In step 305, the second audio has finished playing, and the first electronic device 120 keeps playing the first audio.

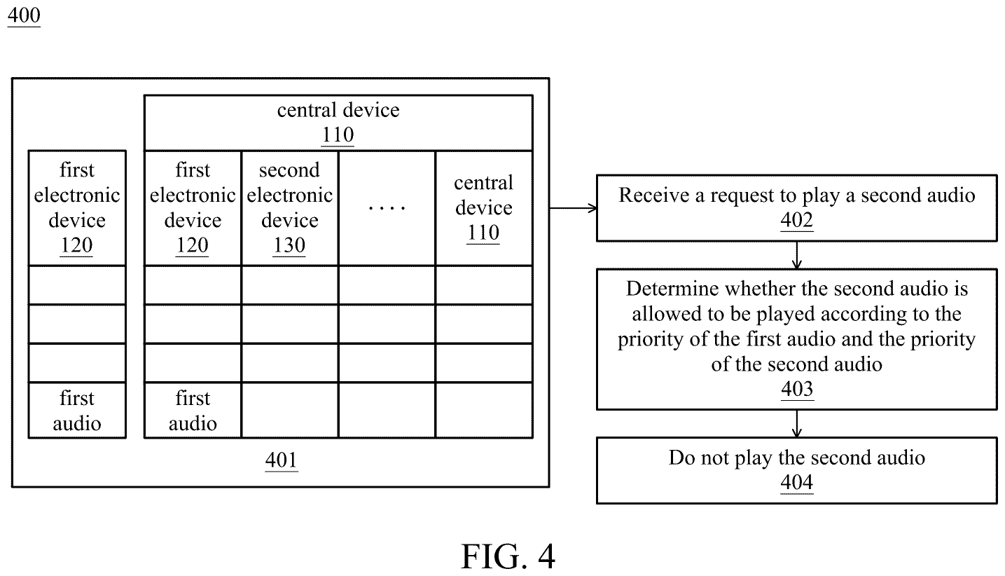

Refer to FIG. 4, which is a schematic diagram of a method 400 for managing audios between different devices in accordance to the embodiments of the present disclosure. In step 401, the first electronic device 120 plays a first audio. In step 402, the audio management server 114 in the central device 110 receives a request to play a second audio from the central device 110 (or the second electronic device 130) through the proxy 113. In step 403, the audio management server 114 of the central device 110 determines whether the second audio is allowed to be played according to the priority of the first audio and the priority of the second audio. In this embodiment, the priority of the second audio is lower than the priority of the first audio. Thus, the central device 110 determines that the second audio is rejected and not to be played, and there is no need to stop the first audio. In step 404, the audio management server 114 of the central device 110 informs the central device 110 (or the second electronic device 130) that the second audio is rejected and not to be played. Thus, the central device 110 (or the second electronic device 130) doesn't play the second audio, after receiving the response from the central device 110. The first electronic device 120 keeps playing the first audio.

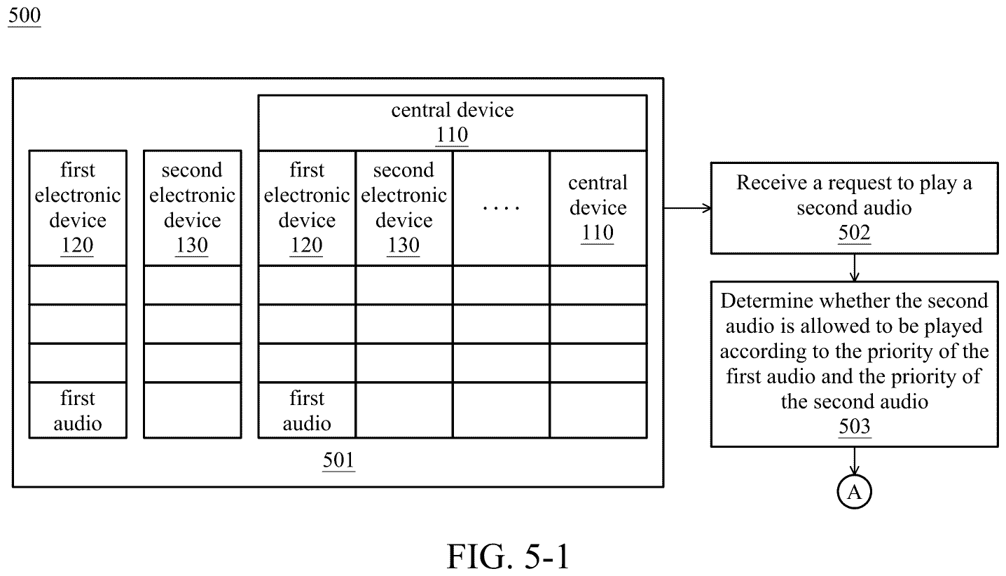

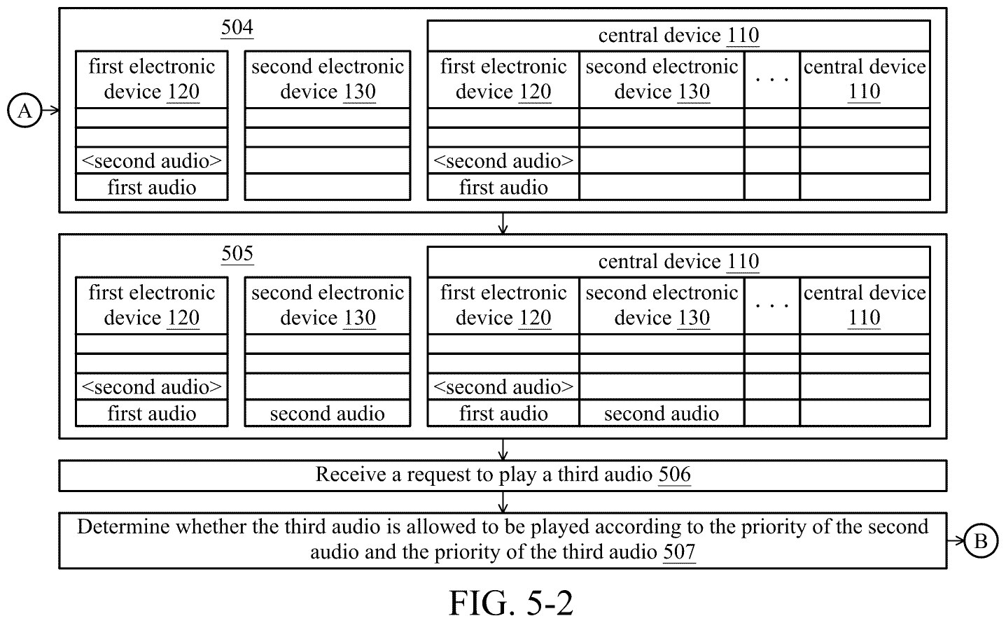

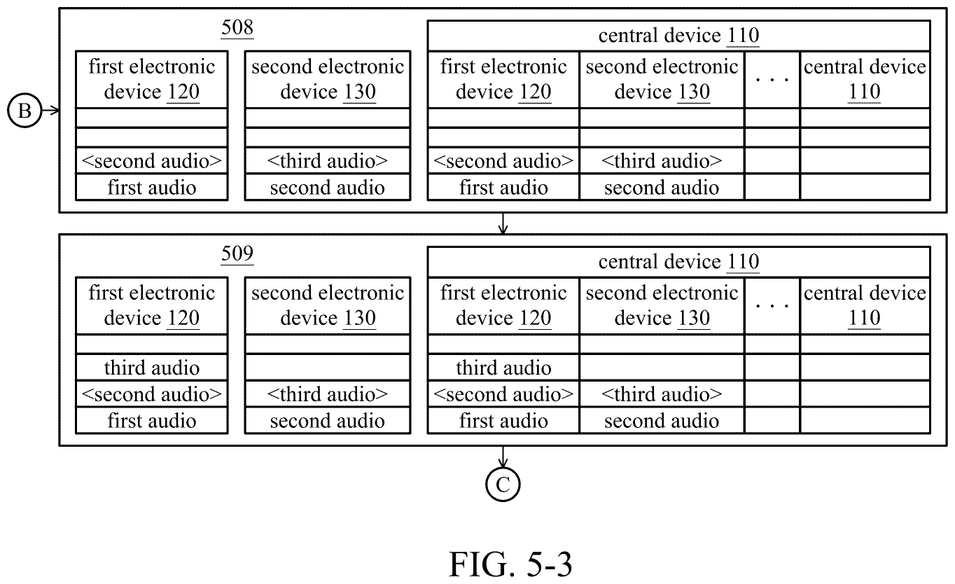

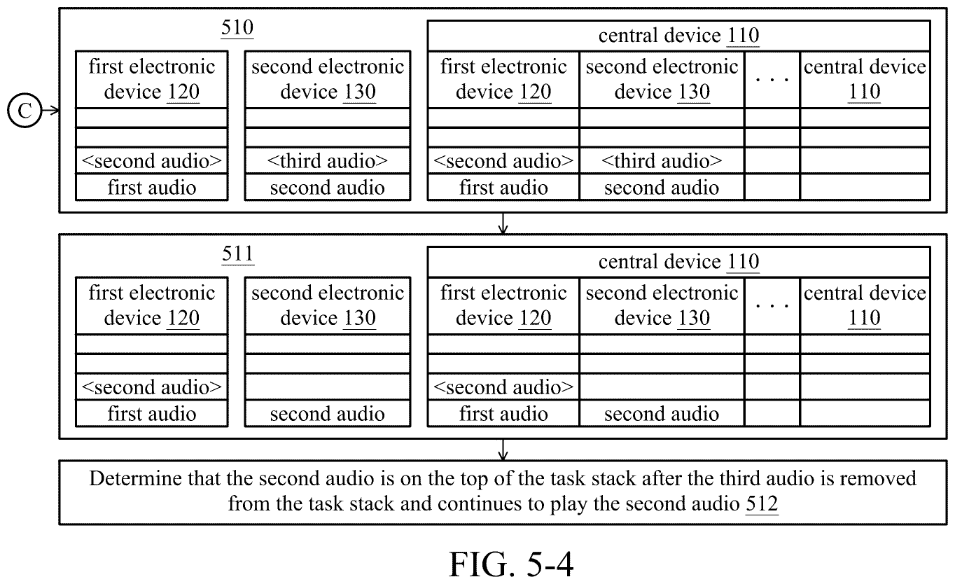

Refer to FIGS. 5-1˜5-4, which is a schematic diagram of a method 500 for managing audios between different devices in accordance with the embodiments of the present disclosure. The audio management method 500 clearly describes the stack strategy for managing multiple tasks or requests, and the stack strategy is used to manage behaviors such as audio playback, pause, stop and release between different electronic devices. The block labeled with “second electronic device 130” illustrates a stack stored in the memory 132 of the second electronic device 130. In step 501, the first electronic device 120 plays a first audio. In step 502, the audio management server 114 in the central device 110 receives a request to play a second audio from the second electronic device 130 through the proxy 113. In step 503, the audio management server 114 of the central device 110 determines whether the second audio is allowed to be played according to the priority of the first audio and the priority of the second audio. In this embodiment, the second audio has a higher priority than the first audio. Thus, the central device 110 determines that the second audio is allowed to be played, and the first audio should be stopped.

In step 504, the central device 110 controls the first electronic device 120 to add the second audio into the top of the task stack of the first electronic device 120 to cause the first electronic device 120 to stop playing the first audio. In FIGS. 5-1˜5-4, parenthesis is used to indicate that a task is added by the central device 110. In other words, parenthesis is used to indicate that a task is from another device, that is to say, a to-be-processed task for another device is added to the top of the stack for the device currently playing audio. In step 505, the audio management server 114 of the central device 110 informs the second electronic device 130 that the second audio is allowed to be played. Thus, the second electronic device 130 plays the second audio, after receiving the response from the central device 110. In step 506, the audio management server 114 in the central device 110 receives a request to play a third audio from the first electronic device 120 through the proxy 113. In step 507, the audio management server 114 of the central device 110 determines whether the third audio is allowed to be played according to the priority of the second audio and the priority of the third audio. In this embodiment, the third audio has a higher priority than the second audio. Thus, the central device 110 determines that the third audio is allowed to be played, and the second audio should be stopped.

In step 508, the central device 110 controls the second electronic device 130 to add the third audio into the top of the task stack of the second electronic device 130 to cause the second electronic device 130 to stop playing the second audio. In step 509, the audio management server 114 of the central device 110 informs the first electronic device 120 that the third audio is allowed to be played. Thus, the first electronic device 120 plays the third audio, after receiving the response from the central device 110.

In step 510, the third audio has finished playing, and the first electronic device 120 removes the third audio from the stack of the first electronic device 120. The first electronic device 120 also informs the audio management server 114 of the central device 110 through the proxy 123 that the third audio has finished playing. In step 511, the central device 110 notifies the second electronic device 130 that the second audio has finished playing, and the second electronic device 130 removes the third audio from the task stack of the second electronic device 130. In step 512, the second electronic device 130 determines that the second audio is on the top of the task stack after the third audio is removed from the task stack and continues to play the second audio. The first electronic device 120 determines that there is another task (the second audio) on the first audio and doesn't play any audio. After the second audio has finished playing, a process similar to steps 510˜512 may be performed to allow the first electronic device 120 to play the first audio.

The method of managing audio in FIGS. 5-1 to 5-4 above clearly describes the stack strategy for managing multiple tasks or requests, which is used to manage audio playback priorities between different electronic devices. Through the audio management method of the present invention, when multiple audio requests occur simultaneously, the system can easily manage audio playback according to predetermined priority rules, ensuring more important audio (such as emergency notifications, alarm sounds or high-priority messages) can interrupt currently playing audio. The audio management method of the present invention can automatically determine which audio should be played without user intervention, thereby reducing the user's burden. It can also ensure that important audio can be played in time, and the interrupted audio can be restored at the appropriate time, which can provide more smoother and more satisfying user experience. When the high-priority audio playback is completed, the system can automatically resume the previously interrupted audio playback so that the user will not miss any information. The audio management method of the present invention not only places the tasks processed by each electronic device in the stack of the electronic device, but also adds the to-be-processed tasks for another device to the top of the stack for the currently playing audio device, providing a clear view of which tasks are waiting to be executed and which tasks have been completed, helping to maintain the order and tracking of tasks. Stack strategies allow the flexibility to add, remove, or change tasks between different devices, which allows the system to easily adapt to new needs or changes. The above flexible stack strategy can achieve audio focus management and synchronization of voice output between multiple electronic devices, helping to reduce resource competition between devices, such as avoiding confusion caused by playing audio from multiple devices at the same time.

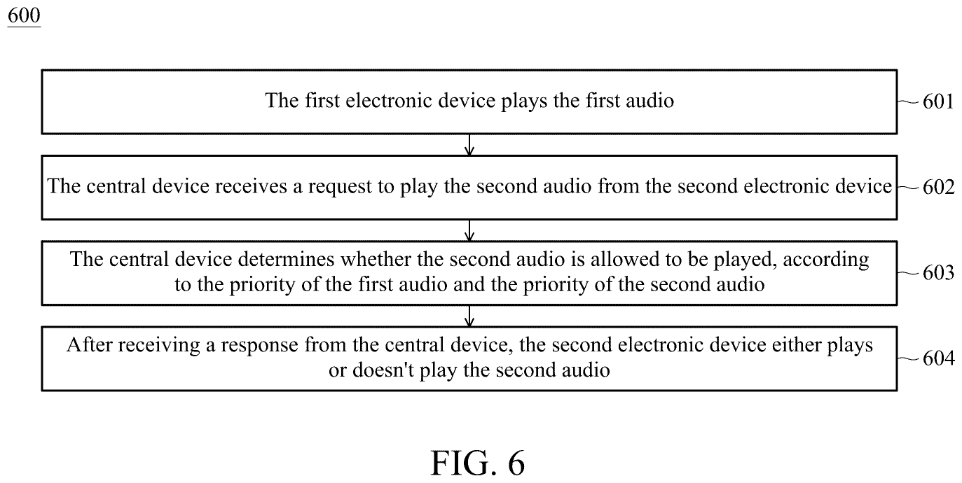

Refer to FIG. 6, which is a flow diagram of a method 600 for managing audios between different devices in accordance to the embodiments of the present disclosure. In step 601, the first electronic device 120 plays the first audio. In step 602, the central device 110 receives a request to play the second audio from the second electronic device 130. In step 603, the central device 110 determines whether the second audio is allowed to be played, according to the priority of the first audio and the priority of the second audio. In step 604, after receiving a response from the central device 110, the second electronic device 130 either plays or doesn't play the second audio. In other words, the second electronic device 130 determines whether to play the second audio following the indication of the response.

In some embodiments, the audios (e.g. the first audio, the second audio, and the third audio) may be, but not limited to, alarm sound, music, and system voice. For example, the alarm sound is an alarm sound for reversing the car, and the system voice is a system voice from the navigation device. In some embodiments, the alarm sound has the highest priority, and the system voice and the music have the same priority. The priority of these audios can be preset or adjusted as needed.

Embodiments for managing audios between different devices are provided. In the embodiments, the audio management server 114 of the central device 110 can control the central device 110, the first electronic device 120, or the second electronic device 130 to play or stop the audios. The audios with higher priorities won't be mixed up with the audios with lower priorities.

The above mentioned different electronic devices (e.g., the central device 110, the first electronic device 120 and the second electronic device 130) may have different operating systems. Compared with multiple electronic devices with the same operating system in the prior art, in order to realize audio focus management in different operating systems, the present disclosure makes the following improvements: ensuring that the operating systems of all electronic devices use the same communication protocol. For example, the above-mentioned Virtual Socket (vsock for short), socket (socket), Remote Procedure Call (grpc for short), Ethernet (Ethernet), Wireless Fidelity (Wi for short)-Fi), Bluetooth, etc. . . . The present disclosure provides audio management methods, which clearly describes the stack strategy for managing multiple tasks or requests, and the stack strategy is independent of what operating systems the electronic devices have and can be shared between the electronic devices having different operating systems. The present disclosure defines a set of standardized interfaces to implement the above audio management methods, and these interfaces can be implemented in different operating systems and follow the same stack strategy to ensure that they respond to audio switching in the same way (for example, the proxy 113 in the central device 110, the proxy 123 of the first electronic device 120, the proxy 133 of the second electronic device 130). The proxy 113, 123 and 133 are a set of standardized interfaces, and the central device 110, the first electronic device 120 and the second electronic device 130 communicate with each other through proxy 113, 123 and 133 respectively).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for managing audios between different devices, comprising:
playing, via a first electronic device, a first audio;
receiving, via a central device, a request to play a second audio from a second electronic device;
determining, via the central device, whether the second audio is allowed to be played, according to a priority of the first audio and a priority of the second audio;
playing or not playing, via the second electronic device, the second audio, after receiving a response from the central device.

2. The method as claimed in claim 1, wherein the first electronic device and the second electronic device have different operating systems.

3. The method as claimed in claim 1, further comprising:
controlling, via the central device, the first electronic device to add the second audio into the top of a task stack of the first electronic device to cause the first electronic device to stop playing the first audio, in response to a determination that the priority of the second audio is higher than the priority of the first audio;
informing, via the central device, the second electronic device that the second audio is allowed to be played; and
playing, via the second electronic device, the second audio.

4. The method as claimed in claim 3, further comprising:
notifying, via the central device, the first electronic device that the second audio has finished playing;
removing, via the first electronic device, the second audio from the task stack of the first electronic device; and
playing, via the first electronic device, the first audio, in response to a determination that the first audio is on the top of the task stack after the second audio is removed from the task stack.

5. The method as claimed in claim 3, further comprising:
receiving, via a central device, a request to play a third audio from the first electronic device;
determining, via the central device, whether the third audio is allowed to be played, according to the priority of the second audio and a priority of the third audio;
controlling, via the central device, the second electronic device to add the third audio into the top of a task stack of the second electronic device to cause the second electronic device to stop playing the second audio, in response to a determination that the priority of the third audio is higher than the priority of the second audio;
informing the first electronic device, via the central device, that the third audio is allowed to be played; and
playing, via the first electronic device, the third audio.

6. The method as claimed in claim 1, further comprising:
informing the second electronic device, via the central device, that the second audio is allowed to be played, in response to a determination that the priority of the second audio is the same as the priority of the first audio; and
playing, via the second electronic device, the second audio, while the first electronic device is playing the first audio.

7. The method as claimed in claim 1, further comprising:
informing the second electronic device, via the central device, that the second audio is rejected and not to be played, in response to a determination that the priority of the second audio is lower than the priority of the first audio.

8. The method as claimed in claim 1, wherein an alarm sound has the highest priority.

9. An audio playback system, comprising:
a first electronic device, configured to play a first audio; and
a central device, configured to:
receive a request to play a second audio from a second electronic device; and
determine whether the second audio is allowed to be played, according to a priority of the first audio and a priority of the second audio;
wherein the second electronic device is configured to play or not to play the second audio, after receiving a response from the central device.

10. The audio playback system as claimed in claim 9, wherein the first electronic device and the second electronic device have different operating systems.

11. The audio playback system as claimed in claim 9, wherein the central device is further configured to:
control the first electronic device to add the second audio into the top of a task stack of the first electronic device to cause the first electronic device to stop playing the first audio, in response to a determination that the priority of the second audio is higher than the priority of the first audio; and
inform the second electronic device that the second audio is allowed to be played;
wherein the second electronic device is configured to play the second audio.

12. The audio playback system as claimed in claim 11, wherein the central device is further configured to notify the first electronic device that the second audio has finished playing;
the first electronic device is further configured to:
remove the second audio from the task stack of the first electronic device; and
play the first audio, in response to a determination that the first audio is on the top of the task stack after the second audio is removed from the task stack.

13. The audio playback system as claimed in claim 11, wherein the central device is further configured to:
receive a request to play a third audio from the first electronic device;
determine whether the third audio is allowed to be played, according to the priority of the second audio and a priority of the third audio;
control the second electronic device to add the third audio into the top of a task stack of the second electronic device to cause the second electronic device to stop playing the second audio, in response to a determination that the priority of the third audio is higher than the priority of the second audio; and
inform the first electronic device that the third audio is allowed to be played;
wherein the first electronic device is configured to play the third audio.

14. The audio playback system as claimed in claim 9, wherein the central device is further configured to inform the second electronic device that the second audio is allowed to be played, in response to a determination that the priority of the second audio is the same as the priority of the first audio;
wherein the second electronic device is configured to play the second audio, while the first electronic device is playing the first audio.

15. The audio playback system as claimed in claim 9, wherein the central device is further configured to inform the second electronic device that the second audio is rejected and not to be played, in response to a determination that the priority of the second audio is lower than the priority of the first audio.

16. The audio playback system as claimed in claim 9, wherein an alarm sound has the highest priority.

17. The audio playback system as claimed in claim 9, wherein the central device, the first electronic device, and the second electronic device are mounted on a vehicle.
